(19) United States
(12) Patent Application Publication
(10) Pub. No.: US 2006/0099039 A1
(43) Pub. Date: May 11, 2006

(54) Vibration machining device and vibration machining method

(75) Inventors: Yuuzou Maki, Anjo-city (JP); Masanori Itou, Toyokawa-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/269,259

(22) Filed: Nov. 8, 2005

(30) Foreign Application Priority Data
Nov. 9, 2004 (JP) 2004-324786
Aug. 31, 2005 (JP) 2005-251629

(51) Int. Cl. B23B 47/28; B23B 47/34

(52) U.S. Cl. 408/1 R; 408/17

(57) ABSTRACT

A vibration machining device comprises a frame that forms a structure, a shaft that is rotatably held by the frame, an actuator that rotatably drives the shaft, a cam that is attached to the shaft and the cam surface of which reciprocates when the cam rotates because its height changes in the direction of rotation axis of the shaft, a spindle that holds a machining tool and which is supported so as to be able to reciprocate in its axial direction, and a transfer mechanism that transfers the reciprocation of the cam surface of the cam such that the spindle reciprocates in its axial direction. The reciprocating motion of the cam surface describes a modified sine curve during the period of one complete rotation of the cam.

### BACKGROUND OF THE INVENTION

1. Field of the Invention

The present invention relates to a vibration machining device and a vibration machining method and, more particularly, to machining equipment and a machining method of a small diameter and small angle tapered deep hole, which is a tapered deep hole having a small diameter and a small angle, and is suitable to an application for machining a refrigerating cycle ejector.

2. Description of the Related Art

Some ejector nozzles used in the refrigerating cycle have a small diameter and small angle tapered deep hole. Machining of such a small diameter and small angle tapered deep hole has brought about a problem that the blade edge of a taper-shaped tool may be broken in relation to a thrust force when the blade edge bites a machined workpiece, because the hole has a small taper angle. If the advancing speed of a tool is reduced in order to prevent the biting phenomenon, the machining efficiency is considerably reduced.

As a countermeasure, a small diameter and small angle tapered deep hole is machined using a wire cutter, an NC lathe, etc., after a prepared hole is completed. FIG. 8 shows a conventional machining method of an ejector nozzle having such a taper of about one degree. The raw material of a nozzle is in general a metal round bar as shown in FIG. 8 (B). In this bar, a prepared hole of about 2 mm φ is formed by small hole electrical discharge machining, gun drill machining, etc (FIG. 8 (C)). Then, the prepared hole is machined so as to have a taper of about one degree by a wire cutter etc. as shown in FIG. 8 (D). A machining-completed product of an ejector nozzle machined as described above is shown in FIG. 8 (A). The time taken for machining in this example is about an hour. The units of the dimensions of the ejector nozzle indicated in FIG. 8 (A), as an example, are mm. There has been a problem that it takes time to machine a small diameter and small angle tapered deep hole such as an ejector nozzle described above, and reduction in the machining time has been required.

In a prior art, an ejector for a refrigerating cycle and its machining method have been disclosed (for example, refer to Patent document 1). However, by the machining method disclosed in this document, it is not possible to obtain a nozzle as described in the present application. Further, in another prior art, a method for machining a long hole and a machining device are disclosed (for example, refer to Patent document 2). Particularly, the supply path of coolant is described. However, by the machining method disclosed in the document, it is also not possible to obtain a nozzle as described in the present application. Furthermore, in another prior art, a configuration of a vibration machining device is disclosed (for example, refer to Patent document 3). However, in the configuration of the machine disclosed in this document, the rotation axis of a drill and the rotation axis of a cam are perpendicular to each other, resulting in an increase in size of the machine.

On the other hand, a gate bush, which is a resin injection part for molding die (a part in contact with a product molding section for injecting melted resin into a die), is shown in FIGS. 12A and 12B. Machining of a gate bush is difficult because high precision is required, and conventionally, a long machining time was taken for it. As for the above-mentioned machining of a gate bush, reduction in machining time has been required while a machining quality of a predetermined level is maintained.

[Patent document 1] Japanese Unexamined Patent Publication (Kokai) No. 2003-139098

[Patent document 2] Japanese Unexamined Patent Publication (Kokai) No. 2002-361506

[Patent document 3] Japanese Unexamined Patent Publication (Kokai) No. 2000-42816

### SUMMARY OF THE INVENTION

The above-mentioned problems being taken into account, the present invention has been developed by focusing on the biting phenomenon of a taper-shaped cutting tool and the object thereof is to provide a machining device and a machining method capable of preventing biting in order to improve machining efficiency of, for example, small diameter and small angle tapered deep hole machining, by applying vibrations with low frequencies and great amplitudes to the tool in order to prevent biting and to reduce the load of the blade edge of the cutting tool and at the same time, by using a modified sine curve as a vibration wave.

Another object of the present invention is to provide machining equipment and a drilling method capable of improving machining efficiency in taper machining such as small diameter and small angle tapered deep hole machining by supplying, under pressure, a coolant from behind a workpiece and by efficiently ejecting the coolant mixed with cutting chips through a machined through-hole which is completed in order to improve the performance of removing and discharging cutting chips, during the cutting operation, in prepared hole machining.

Another object of the present invention is to provide a drilling device and a drilling method capable of machining, highly precisely and in a short time, a taper of about one degree of an ejector nozzle by utilizing these techniques.

Still another object of the present invention is to provide a vibration machining device and a vibration machining method capable of easily adjusting a machining condition such as a vibration amplitude.

In order to attain the above-mentioned objects, in a first aspect of the present invention, a vibration machining device (1, 101) comprises a shaft (22) rotatably held by a frame (11), which is a structure of the vibration machine device, an actuator (19) that rotatably drives the shaft (22), a motion conversion mechanism (23, 24, 70, 81) attached to the shaft (22) and converting a rotational motion into a reciprocating motion, a spindle (12) that holds a machining tool (2) and is supported in the frame (11) so as to be able to reciprocate in the axial direction thereof, and a transfer mechanism (16) that transfers the reciprocating motion of the motion conversion mechanism (23, 24, 70, 81) such that the spindle (12) reciprocates in its axial direction.

With this configuration, biting is prevented by focusing on the biting phenomenon of a taper-shaped cutting tool in order to improve machining efficiency of, particularly, small diameter and small angle tapered deep hole machining and by applying vibrations with low frequencies and great amplitudes to the cutting tool in order to prevent biting and reduce the load of the blade edge of the cutting tool. For example, it is possible to machine highly precisely in a short time a taper of about one degree when machining a small diameter and small angle tapered deep hole such as an ejector nozzle.

In a second aspect of the present invention according to the above-mentioned first aspect, the reciprocating motion of the motion conversion mechanism (23, 24, 70, 81) describes a modified sine curve during the period of its one complete rotation.

According to the present aspect, particularly, biting can be prevented effectively and, further, machining efficiency and machining precision can be improved when machining a small diameter and small angle tapered deep hole such as an ejector nozzle by using a modified sine curve as a waveform of vibrations with low frequencies and great amplitudes to be applied to the cutting tool.

In a third aspect of the present invention according to the above-mentioned second aspect, the modified sine curve described by the reciprocating motion of the motion conversion mechanism (23, 24, 70, 81) is such that during the period of its one complete rotation, its height gradually increases from a position of a lower dead center toward a position of an upper dead center and gradually decreases from the position of the upper dead center toward the position of the lower dead center, and the modified sine curve has constant velocity parts (constant level parts) without displacement by reciprocation in a specific rotation angle range of the modified sine curve in the vicinity of the position of the lower dead center and in a specific rotation angle range thereof in the vicinity of the position of the upper dead center.

According to the present aspect, the shape of the modified sine curve is made more concrete, which more effectively prevents biting to prevent the machining (cutting) tool from being broken and improves machining efficiency and machining precision by repeating sticking-in, cutting, and backing of a machining (cutting) tool at a high speed in order to make the influence of the machining-hardened layer more unlikely to affect thereon.

In a fourth aspect of the present invention according to the above-mentioned third aspect, the specific rotation angle range in the vicinity of the position of the lower dead center and the specific rotation angle range in the vicinity of the position of the upper dead center, in which the constant level (velocity) parts are formed, are a range between substantially ±5 degrees to a range between substantially ±15 degrees when the position of the lower dead center or the position of the upper dead center are the centers of the specific rotation angle ranges, respectively.

According to the present aspect, the shape of the modified sine curve effective for preventing biting is made even more concrete.

A fifth aspect of the present invention according to the above-mentioned third or fourth aspect, during the period of one complete rotation of the motion conversion mechanism (23, 24, 70, 81), which corresponds to 360 degrees, if the position of the above-mentioned lower dead center is assumed to be at zero degree, the position of the above-mentioned upper dead center is at 180 degrees.

According to the present aspect, the modified sine curve effective for preventing biting is made more concrete.

In a sixth aspect of the present invention according to any one of the above-mentioned first to fifth aspects, the motion conversion mechanism comprises a cam (23) attached to the shaft (22) and a roller (24). The cam surface of the cam (23) is formed such that the height of the cam surface changes in a direction of a rotation axis of the shaft (22) when the cam (23) rotates together with the shaft (22), and as the roller (24) is engaged with the cam surface, the roller (24) reciprocates when the shaft (22) rotates.

According to the present aspect, the configuration of the motion conversion mechanism is made more concrete.

A seventh aspect of the present invention according to any one of the above-mentioned first to fifth aspects, the motion conversion mechanism comprises a disc-like swash plate (70) attached to the shaft (22) so as to incline with respect to the rotation axis of the shaft (22) and a pair of roller guides (81). The pair of roller guides (81) is arranged so as to be adjacent to and sandwich the outer circumferential edge of the disc surface of the swash plate (70) and as the swash plate (70) slides between the pair of roller guides (81) when it rotates, the roller guides (81) reciprocate, and further the roller guides (81) are connected to the transfer mechanism (16).

According to the present aspect, another concrete configuration of the motion conversion mechanism is disclosed.

An eighth aspect of the present invention according to the above-mentioned seventh aspect further comprises a swash plate inclination angle change mechanism for changing the inclination angle of the swash plate with respect to the shaft (22).

According to the present aspect, the inclination angle of the swash plate can be changed, therefore, it is possible to change and adjust the amplitude of vibration of the machining tool even during the period of machining and to easily set optimum machining conditions.

In a ninth aspect of the present invention according to the above-mentioned eighth aspect, the swash plate inclination angle change mechanism comprises a pin (71) that connects the swash plate (70) to the shaft (22) and around which the swash plate (70) can rotate, a slide block (73) that can move along the shaft (22), an arm (72) that links the swash plate (70) and the slide block (73), and a drive mechanism (75) that can move the slide block (73) along the shaft (22).

According to the present aspect, the configuration of the swash plate inclination angle change mechanism is made more concrete.

In a tenth aspect of the present invention according to the above-mentioned ninth aspect, the drive mechanism comprises a drive device such as a stepping motor, a servomotor, and a pneumatic or hydraulic actuator and is automatically controlled so as to optimize the vibration amplitude of the machining tool (2).

According to the present aspect, by automatically controlling the swash plate inclination angle change mechanism, it is possible to optimize machining conditions.

An eleventh aspect of the present invention according to any one of the above-mentioned first to tenth aspects is used for machining a small diameter and small angle tapered deep hole.

According to the present aspect, the use of the present invention is made more concrete.

In a twelfth aspect of the present invention according to the above-mentioned eleventh aspect, the taper of the small diameter and small angle tapered deep hole is about one degree.

According to the present aspect, machining in which the use of the vibration machining device of the present invention is effective is made more concrete.

In a thirteenth aspect of the present invention according to any one of the above-mentioned first to twelfth aspects, the vibration machining device (1) is attached to a drilling device (100), and the drilling device (100) comprises a main spindle (3) that rotates. While rotating a workpiece (4) set to the main spindle (3), the vibration machining device drills the workpiece by vibrating the machining tool (2) attached to the vibration machining device (1).

According to the present aspect, the tool itself attached to the vibration machining device does not rotate itself but vibrates back and forth and a deep hole can be machined while a workpiece to be machined is rotating, therefore, it is possible to machine a small diameter and small angle tapered deep hole with less error of the hole center.

In a fourteenth aspect of the present invention, machining equipment for supplying a coolant liquid for cutting to a machine tool comprises: a first connection opening (28) communicating a supply source of the coolant liquid; a second connection opening (30) communicating the machine tool; a first channel for fluidly connecting the first connection opening (28) and the second connection opening (30); a second channel branching from the first channel; a third connection opening (29) capable of making the coolant liquid flowing through the second channel flow out or flow in the machining equipment; a first switch valve (32) installed on the side nearer to the first connection opening than a branching point of the second channel in the first channel and opening and closing the first channel; and a second switch valve (34) installed on a side nearer to the third connection opening than the branching point of the second channel, in the second channel and opening and closing the third channel.

With this configuration, it is possible to improve machining efficiency in drilling such as small diameter and small angle tapered deep hole machining by supplying pressurized coolant from behind a workpiece and by efficiently discharging the coolant mixed with cutting chips when a prepared hole is completed in order to improve performance of discharging cutting chips during the cutting operation in prepared hole machining.

In a fifteenth aspect of the present invention according to the above-mentioned fourteenth aspect, the machine tool has a rotary spindle that rotates and the machining equipment further comprises a rotary joint (6) of swivel type that can be connected to the rotary spindle at the second connection opening (30).

According to the present aspect, a construction in which a machining equipment can be connected to the main spindle etc. of the machine tool that rotates is made concrete.

In a sixteenth aspect of the present invention according to the above-mentioned fourteenth or fifteenth aspect, the first switch valve (32) and the second switch valve (34) are remotely operated.

According to the present aspect, the operation of the machining equipment of the present invention is made easier.

A seventeenth aspect of the present invention according to any one of the above-mentioned fourteenth to sixteenth aspects further comprises the vibration machining device (1, 101) set forth in any one of the first to thirteenth aspects and is used in combination with the vibration machining device (1, 101).

According to the present aspect, by combining the vibration machining device and the machining equipment capable of supplying coolant liquid, the load of the blade edge of the cutting tool is further reduced, biting of the cutting tool is prevented to prevent the cutting tool from being broken, and machining efficiency is improved particularly in small diameter and small angle tapered deep hole machining and it is possible to machine highly precisely in a short time a taper of about one degree when machining, for example, a small diameter and small angle tapered deep hole, such as an ejector nozzle.

A vibration machining method for drilling a small hole in an eighteenth aspect of the present invention comprises a step for machining a prepared hole in a workpiece by electric discharge machining, gun drill machining, or the like; and a step for machining the prepared hole in a taper hole by inserting the machining tool (2) into the prepared hole while rotating the workpiece and vibrating the machining tool (2) in the direction parallel to the rotation axis of the workpiece.

According to the small hole machining method of the present aspect, biting is prevented by focusing on the biting phenomenon of a taper-shaped cutting tool, in order to improve machining efficiency of, particularly, small diameter and small angle tapered deep hole machining and by applying vibrations with low frequencies and great amplitudes to the tool in order to prevent biting and in order to reduce the load of the blade edge of the cutting tool. For example, it is possible to machine highly precisely and in a short time a taper of about one degree when machining a small diameter and small angle tapered deep hole such as an ejector nozzle.

A nineteenth aspect of the present invention according to the above-mentioned eighteenth aspect further comprises a step for inserting the machining tool (2) from one end of the prepared hole, which is a through hole, and supplying the coolant liquid from the other end of the prepared hole.

According to the present aspect, by combining the vibration machining device and the machining equipment capable of supplying a coolant liquid, the load of the blade edge of the cutting tool is further reduced, biting of the cutting tool is prevented to prevent the tool from being broken, and machining efficiency is improved particularly in small diameter and small angle tapered deep hole machining and it is possible to machine highly precisely in a short time a taper of about one degree when machining, for example, a small diameter and small angle tapered deep hole such as an ejector nozzle.

A twentieth aspect of the present invention according to the above-mentioned eighteenth or nineteenth aspect further comprises a step for adjusting the amplitude of vibration of the machining tool (2) to an optimum value.

According to the present aspect, as it is possible to adjust the amplitude of the machining tool to an optimum value, complex and precise machining can be performed.

Further, compared to conventional machining methods, reduction in machining time and extension of life of the machining tool can be expected.

Vibration machining methods in twenty-first and twenty-second aspects of the present invention use the vibration machining device (1, 101) set forth in any one of the above-mentioned first to thirteenth aspects and the machining equipment set forth in the above-mentioned seventeenth aspect.

According to these aspects, the machining equipment capable of performing the vibration machining method is made concrete.

In a twenty-third aspect of the present invention according to the above-mentioned twenty-second aspect, the coolant liquid is supplied from the tool side in the step for machining a prepared hole and the first switch valve (32) is closed and the second switch valve (34) is open in the machining equipment, therefore, the coolant liquid is discharged through the third connection opening (29) of the machining equipment when the prepared hole is completed.

According to the present aspect, it is possible to improve machining efficiency because cutting chips are discharged effectively in drilling a prepared hole for a small hole, such as, particularly, a small diameter and small angle tapered deep hole.

In a twenty-fourth aspect of the present invention, a method for manufacturing an ejector for refrigerating cycle in which a taper hole is machined in an ejector nozzle uses the vibration machining method set forth in any one of the above-mentioned eighteenth to twenty-third aspects.

According to the method for manufacturing an ejector for refrigerating cycle of the present aspect, the cutting tool is prevented from being broken and machining efficiency is improved by reducing the load of the blade edge of the cutting tool to prevent biting of the cutting tool, and it is possible to machine highly precisely in a short time a tapered hole of an ejector nozzle.

The present invention may be more fully understood from the description of the preferred embodiments of the invention set forth below, together with a accompanying drawings.

### BRIEF DESCRIPTION OF THE DRAWINGS

In the drawings:

FIG. 1 is a schematic front view including a partial section of a vibration machining device in a first embodiment of the present invention.

FIG. 2 is a view in the direction of the arrow A in FIG. 1 showing a state in which the vibration machining device in FIG. 1 is mounted on a general-purpose NC lathe, also showing a section partially.

FIG. 3 is an explanatory diagram of a cam curve 25 of the outer circumferential part of a vibration cam, which is a component of the vibration machining device in FIG. 1.

FIG. 4 shows a pneumatic circuit diagram of the vibration machining device in the first embodiment of the present invention.

FIG. 5 shows machining equipment in a second embodiment of the present invention, in which a combination of a small diameter and small angle tapered deep hole vibration machining device 1 and a back coolant supply section 5 is applied to ejector nozzle machining.

FIG. 6A is a partial sectional side view of the back coolant supply section 5 showing the structure thereof.

FIG. 6B is a view in the direction of the arrow B in FIG. 6A including the partial section.

FIG. 7 is a perspective view showing particularly the shape of an outer circumferential groove of the vibration cam of the vibration machining device in the first embodiment.

FIG. 8 shows an explanatory diagram about a machining method of an ejector nozzle in the prior art.

FIG. 9 shows an illustrative perspective view of a vibration machining device 101 in a third embodiment of the present invention.

FIG. 10 is a side sectional view of the vibration machining device 101 in the third embodiment.

FIG. 11 is a side sectional view showing the outline of a resin molding die 150.

FIG. 12A is a side sectional view of the entire shape of a gate bush.

FIG. 12B is a detailed sectional view of a portion 12B of an injection section in FIG. 12A.

FIG. 13 shows an example of machining of a gate bush having an opening of complex shape, by a vibration machining method using the vibration machining device in the third embodiment, in a state in which it is cut at its center near the injection section.

### DESCRIPTION OF THE PREFERRED EMBODIMENTS

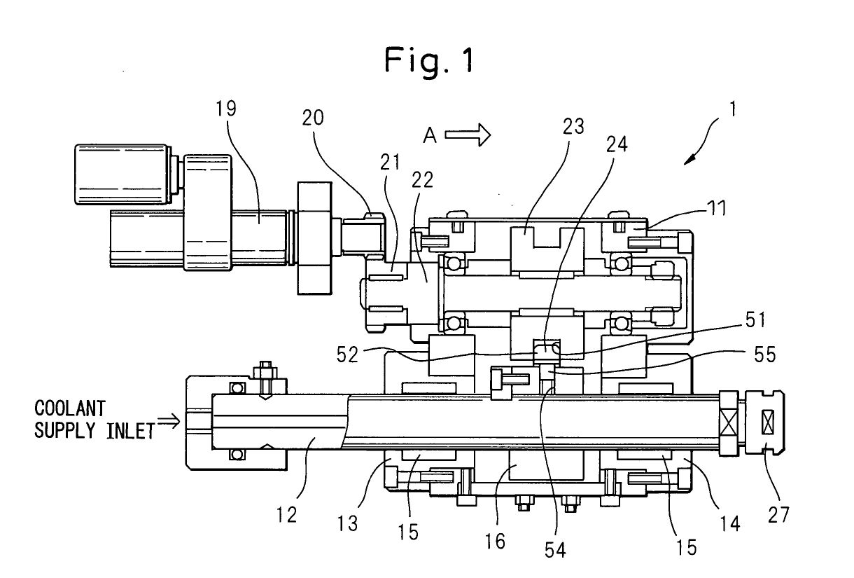

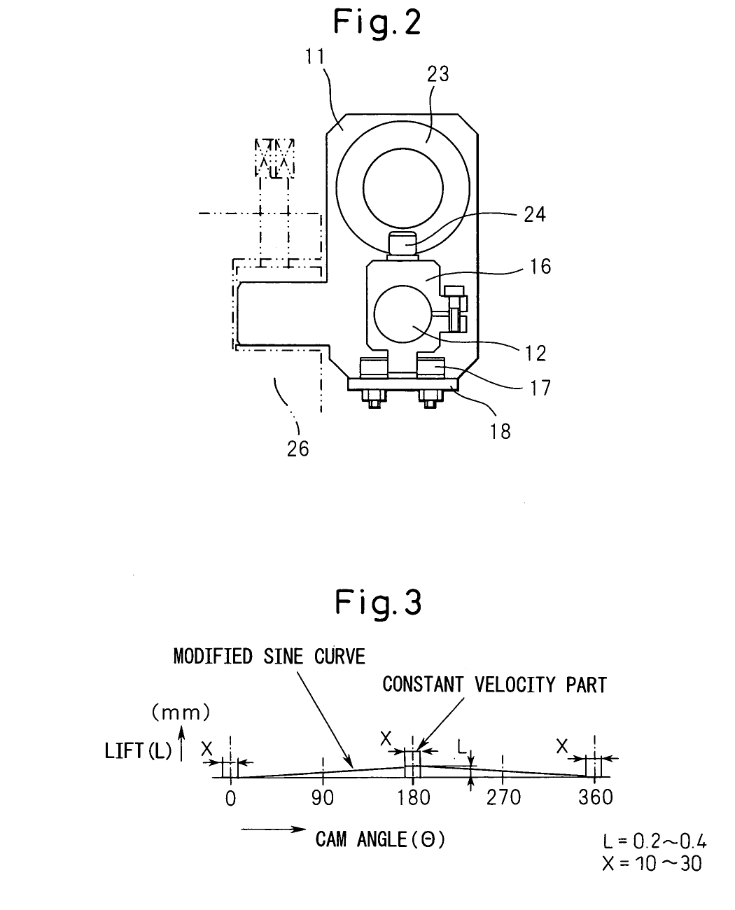

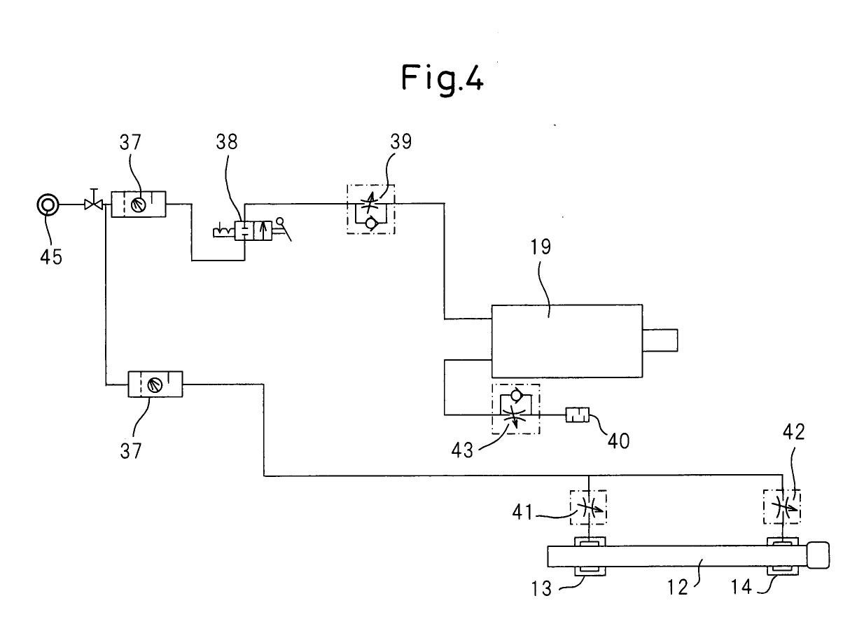

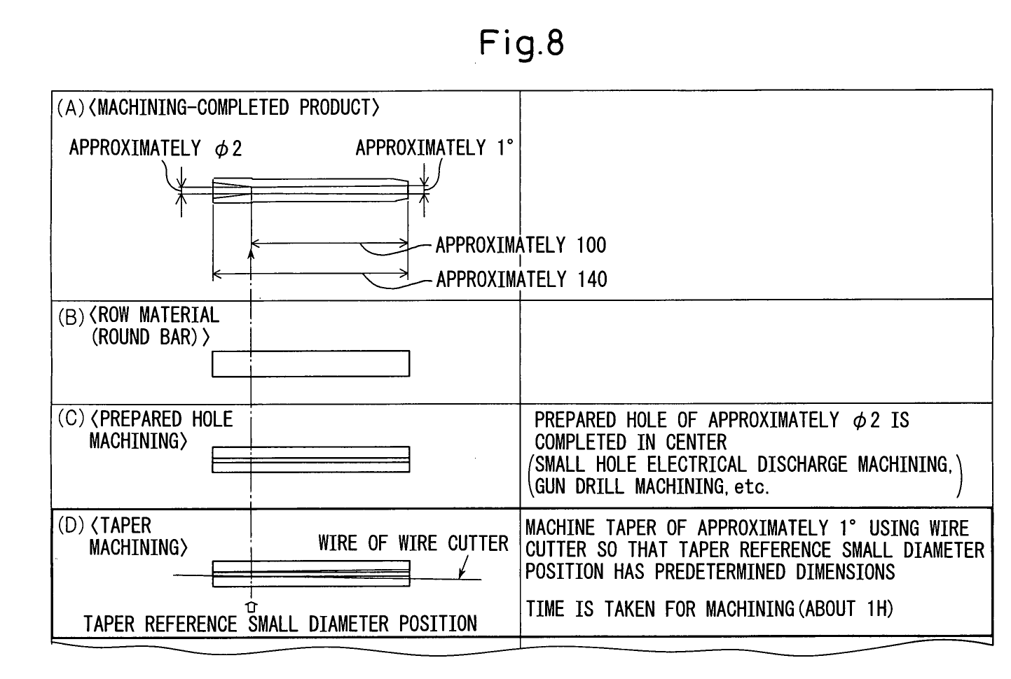

The machining device in embodiments of the present invention is explained below in detail with reference to drawings. FIG. 1 to FIG. 4 illustratively show the first embodiment of the vibration machining device according to the present invention: FIG. 1 is a schematic partial sectional front view of the vibration machining device of the first embodiment according to the present invention and FIG. 2 is a schematic side view in the direction of the arrow A in FIG. 1 including a partial section in a state in which the vibration machining device in FIG. 1 is mounted on a general-purpose NC lathe. FIG. 3 is an explanatory diagram of a cam curve 25 of the outer circumferential part of a vibration cam, which is a component of the vibration machining device in FIG. 1 and FIG. 4 shows a pneumatic circuit diagram of the vibration machining device in the first embodiment according to the present invention. In the following explanation of the embodiments, a workpiece to be machined as an example is the previously described ejector nozzle used in a refrigerating cycle and shown in FIG. 8. In machining of a small diameter and small angle tapered deep hole of the ejector nozzle in the refrigerating cycle shown in FIG. 8, preferably the taper is finished with 1° (degree) ±20′ (minutes).

Referring to FIG. 1 first, a vibration machining device 1 for a small diameter and small angle tapered deep hole that enables small diameter and small angle tapered deep hole machining, that is, the vibration machining device in the first embodiment of the present invention, is shown. The vibration machining device 1 comprises a vibration spindle 12, a vibration cam 23, and an air actuator 19, and these components are incorporated in a frame 11. The vibration machining device of the present application applies vibrations to a machining tool when drilling and the vibrations are generated by the air actuator 19. Preferably, the pneumatic actuator 19 is, for example, an actuator such as an air motor, etc. that is pneumatically operated and rotated. The rotation of the pneumatic actuator 19 causes the vibration cam 23 to rotate via a gear 20 connected to the pneumatic actuator 19 and a gear 21 connected to a shaft 22. The shaft 22 is rotatably supported by the frame 11 via bearings.

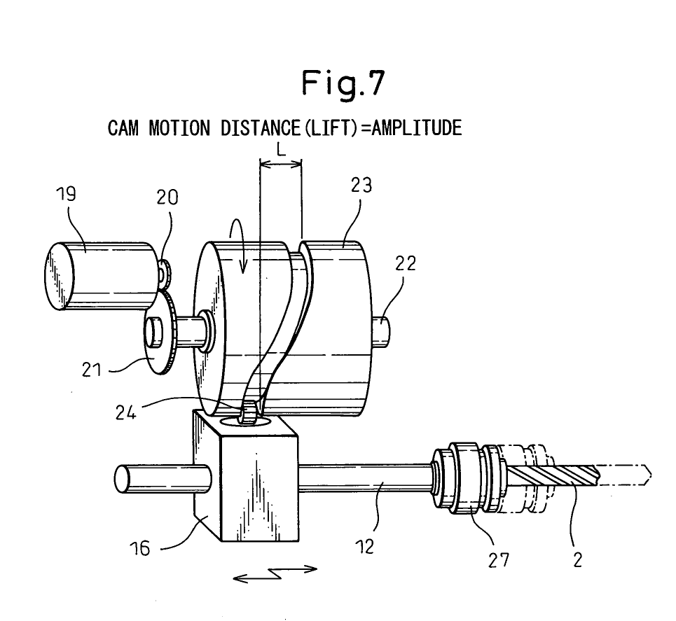

The vibration cam 23 is a drum cam (refer to FIG. 7) and a groove 51 is formed in the center of its outer circumference, as shown in FIG. 1. A cylindrical end part 52, which is one end part of a roller 24, is engaged with the groove 51. The groove 51 is formed around the entire outer circumference of the vibration cam 23 such that during one complete rotation of the vibration cam 23, the roller 24 is guided through the groove 51 (it can be regarded that the groove 51 makes one complete rotation along the roller 24). Therefore, the width of the groove 51 is substantially the same as the diameter of the one end part of the roller 24 along the entire circumference. The other end part 55 of the roller 24 is also cylindrical and engaged with a circular recess part 54 of a holder 16 fixed to the vibration spindle 12. The vibration spindle 12 is supported by bearings 13 and 14 in its radial direction, and is movably supported in its axial direction. According to the rotation of the vibration cam 23, the vibration spindle 12 reciprocates in its axial direction via the holder 16 that functions as a transfer mechanism. In the present embodiment, the vibration cam 23 and the roller 24 form a motion conversion mechanism set forth in claims that converts a rotational motion into a reciprocating linear motion (reciprocation).

The groove 51 on an outer circumferential part of the vibration cam 23 is formed so as to describe a cam curve 25 and the cam curve 25 is a modified sine curve. The shape of the groove 51 of the vibration cam 23, which is a drum cam, is understandable from the illustrative perspective view shown in FIG. 7. The development of the cam curve 25 is shown in FIG. 3. In the development of the cam curve 25 in FIG. 3, the horizontal axis represents the rotation angle θ during the period of one complete rotation of the vibration cam 23 and the vertical axis represents the change in the displacement L (the lift) in the axial direction of the shaft 22 in the groove 51 on the outer circumferential part of the vibration cam 23. The lift L of the vibration cam 23 causes the roller 24 to reciprocate in the axial direction of the vibration spindle 12 and finally the vibration spindle 12 is reciprocated in a specific displacement (equal to the lift L in the present embodiment) in the axial direction thereof. If it is assumed that the reference position (the lower dead center: the lift=0), at which the displacement is minimum, is when the rotation angle θ of the vibration cam 23 is 0°, the displacement reaches its maximum (the upper dead center) at 180°, that is, when the vibration cam 23 makes a half rotation, and in the present embodiment, it is preferably 0.2 to 0.4 mm (the lift L=0.2 to 0.4). FIG. 3 shows that it is preferable in the modified sine curve of the present application that the displacement L (the lift) of the vibration cam 23 gradually increases in substantially a sine curve when the rotation angle changes from 0° to 180°, and that the displacement of the vibration cam 23 gradually decreases in substantially a sine curve when the rotation angle changes from 180° to 360° (the original position at 0°). Further, in the cam curve 25 of the present embodiment, it is preferable to provide a specific range (a constant velocity part or a constant level part) in which the displacement L (the lift) does not change at the position at which the displacement L of the vibration cam 23 is minimum (the lower dead center) and the rotation angle θ is 0° and at the position at which the displacement L is maximum (the upper dead center) and the angle is 180°, and preferably, the constant velocity part is in a range of substantially ±5° to ±15° (substantially 30° in total). As the constant velocity parts (constant level parts) are provided at the position at which the displacement L is minimum (the lower dead center) and at the position at which the displacement L is maximum (the upper dead center), and in the drilling operation in this embodiment, three steps, i.e., sticking a tool into a workpiece (sticking-in), cutting the workpiece by the tool (cutting) and drawing back the tool (backing), are repeated. Therefore, the influence of the machining-hardened layer of the workpiece against the drilling operation is reduced, so that the cutting ability is improved.

The groove 51 of the vibration cam 23 is formed as the cam curve 25, which is a modified sine curve and, therefore, the reciprocating (swinging) motion obtained from the cam curve 25 is transferred to the vibration spindle 12 via the roller 24 and the holder 16 attached to the vibration spindle 12. In this way, the change (the cam curve 25) in the displacement L (that is, the lift) in the axial direction of the vibration cam 23 parallel to the rotation axis of machining equipment generates displacement in the axial direction of the roller 24 and is finally transferred to the vibration spindle 12, causing the vibration spindle 12 to reciprocate also in the axial direction parallel to the rotation axis of the machining equipment. The vibration spindle 12 is pneumatically supported by mist air that is supplied in an air pocket 15 provided at the bearings 13 and 14 attached to the frame 11 and which flows out from the bearings 13 and 14 and, therefore, a smooth reciprocating motion is made possible. Further, as shown in FIG. 2, two rollers 17 attached to a detent 18 attached to the frame 11 come into contact with the holder 16 so as to sandwich it from both sides, thereby the force in the rotation direction of the vibration spindle 12 is supported. In this configuration, the vibration spindle 12 does not rotate around its own center axis.

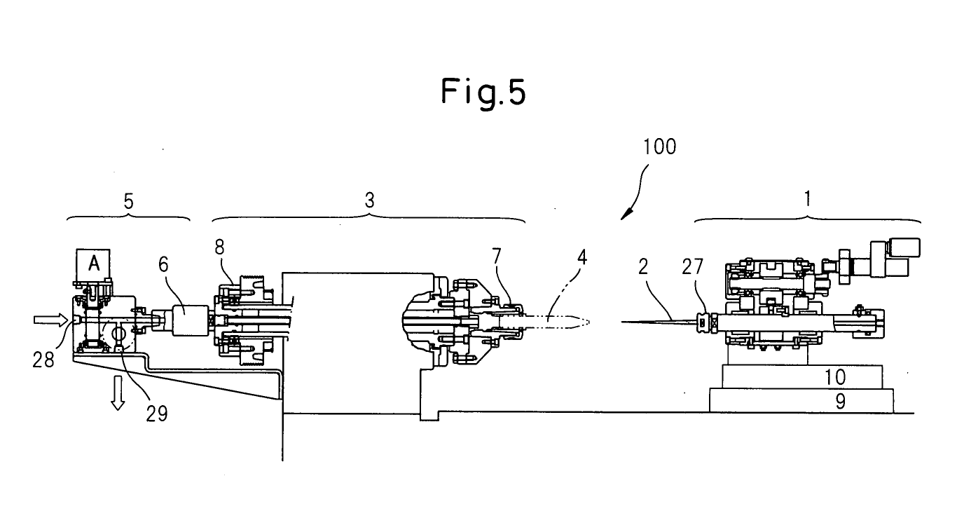

As the present device can be made compact and light, it is possible to easily attach it to, for example, a general-purpose lathe (refer to FIG. 5). When it is used, as shown in FIG. 2, the protruding part of the frame 11 is fixed to a tool rest 26 of the general-purpose NC lathe etc. A taper-shaped tool 2 (shown in FIG. 5 or FIG. 7) is held and fixed by a tool holder 27 provided at the vibration spindle 12. A general-purpose lathe, which is a drilling device 100 to which the present device 1 has been attached, comprises a main spindle 3, and an ejector nozzle 4, which is a workpiece, is held by a workpiece holder 7 at the top end of the main spindle. The vibration machining device 1 in the present embodiment is attached to the drilling device 100 in a state of being in opposition to the workpiece 4. In this state, the general-purpose lathe rotates the workpiece 4 and by inserting the taper-shaped tool 2 attached to the vibration machining device 1 in the present embodiment into a prepared hole of the workpiece 4 and performing vibration machining, it is possible to machine a preferable small diameter and small angle tapered deep hole of, for example, 1°±20′.

In the small diameter and small angle tapered deep hole vibration machining device 1 in the present embodiment, various components such as the pneumatic actuator 19 comprise pneumatic devices. FIG. 4 shows a pneumatic circuit diagram of the small diameter and small angle tapered deep hole vibration machining device 1. The configuration and operation of the pneumatic circuit are explained below. Pressurized air is supplied from a pneumatic supply source 45 and rotatably operates the pneumatic actuator 19 via the pneumatic circuit. The frequency of the small diameter and small angle tapered deep hole vibration machining device 1 in the present embodiment is, as known from above, in proportion to the rotation speed of the pneumatic actuator 19. Therefore, it is possible to change the rotation speed of the pneumatic actuator 19 by changing the flow rate of supplied air using flow rate control valves 39 and 43 provided at the front and rear of the pneumatic actuator 19. Air supplied to a pneumatic auxiliary device 37 generally including a filter, a lubricator, a pressure control valve, etc., is supplied to the bearings 13 and 14 via flow rate control valves 41 and 42 and supports the vibration spindle 12. When turned ON, a start-up valve 38 supplies air to the pneumatic actuator 19 via the flow rate control valve 39 and when turned OFF, it stops the supply of air. Exhaust air is discharged into the atmosphere through a silencer 40 of the flow rate control valve 43.

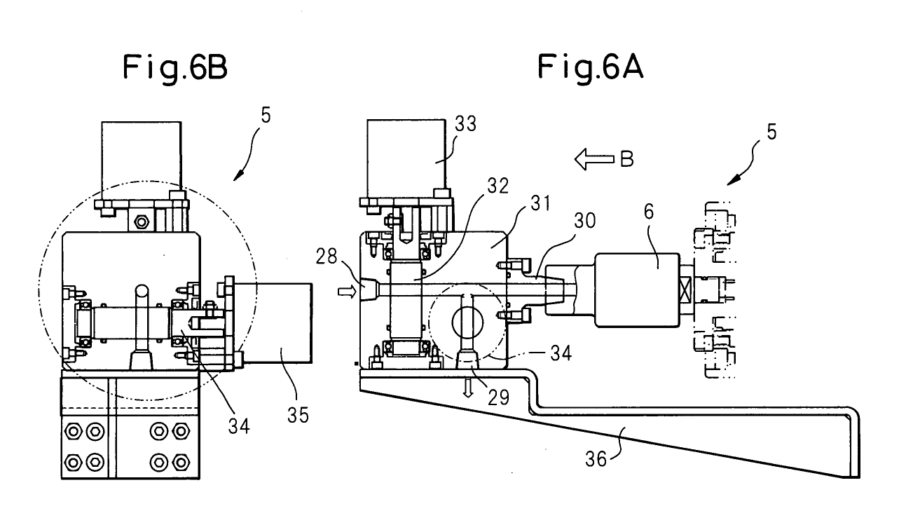

Machining equipment in a second embodiment of the present invention comprises a back coolant supply section 5 for supplying a high pressure coolant from behind a workpiece as a means to improve machining efficiency, in addition to the small diameter and small angle tapered deep hole vibration machining device 1. FIGS. 6A and 6B are structural drawings of the back coolant supply section 5: FIG. 6A is its partial sectional side view and FIG. 6B is a view in the direction of the arrow B in FIG. 6A, partially showing the section thereof. The back coolant supply section 5 has two connection openings, that is, a connection opening 28 through which a high pressure coolant is supplied and a connection opening 29 through which a mixture of coolant and cutting chips that are discharged through a prepared hole when the prepared hole is completed using a tool such as gun drill. The supply section 5 comprises a rotary joint 6 attached to the main spindle 3 of the general-purpose NC lathe etc., a joint 30 that connects a body 31 and the rotary joint 6 of the supply section 5, switch valves 32 and 34 for controlling the flow of the coolant, and rotary actuators 33 and 35, which are driving sources of the switch valves 32 and 34, respectively, and the supply section 5 is fixed to the general-purpose NC lathe etc. by a mounting stay 36. The rotary actuators 33 and 35 may be an actuator of well-known type such as a pneumatic type or an electric type, or may be an actuator of reciprocation type other than the rotary type depending on the type of switch valve.

The operation of the back coolant supply section 5 in the above-mentioned configuration is explained below.

The high pressure coolant that has flowed in from the connection opening 28 passes through the flow passage of the body 31 when the switch valve 32 is in an open state and the switch valve 34 is in a closed state, and is supplied to the back of the workpiece 4 through the joint 30, the rotary joint 6 and the inside of the main spindle of the general-purpose NC lathe etc. The supplied coolant functions as a cooling and lubricating liquid to improve machining efficiency in machining of a taper by the small diameter and small angle tapered deep hole vibration machining device 1. The rotary joint 6 fluidly connects the main spindle section of the lathe etc. that rotates and the back coolant supply section 5 that is static and has a swivel configuration in which the side of the main spindle section rotates and the side of the supply section 5 does not rotate.

On the other hand, when small diameter and small angle tapered deep hole machining is performed using an NC lathe, it is possible to machine a prepared hole using a gun drill etc. In this case, a gun drill is provided on the side of the small diameter and small angle tapered deep hole vibration machining device 1 and a workpiece held by the lathe is rotated, and a coolant liquid is supplied on the side of the gun drill. A mixture of cutting chips in the coolant liquid will reduce machining efficiency. However, by connecting the back coolant supply section 5 to the main spindle section 3 of the lathe, it is possible to recover the coolant liquid, mixed with cutting chips produced when a prepared hole is completed, into an installed coolant tank by bringing the switch valve 32 into the closed state and the switch valve 34 into the open state. Due to this, machining efficiency can be improved. This control may be performed by utilizing the extended control function of the general-purpose NC lathe, etc., or may be performed by an individual control unit.

The operation of the machining equipment comprising the small diameter and small angle tapered deep hole vibration machining device 1 and the back coolant supply section 5 in the present embodiment is explained below.

The drilling device 100 is shown in FIG. 5, which is applied to an ejector nozzle machining equipment by combining the small diameter and small angle tapered deep hole vibration machining device 1 and the back coolant supply section 5. The small diameter and small angle tapered deep hole vibration machining device 1 is mounted on an X slide 10 of the general-purpose NC lathe and the taper-shaped tool 2 is fixed to the tool holder 27 provided in front of the vibration spindle 12. The workpiece 4 is fixed to the workpiece holder 7 of the main spindle 3 of the general-purpose NC lathe etc. The back coolant supply section 5 is fixed to the main spindle section 3 of the general-purpose NC lathe etc. so as to connect it to a rotation transfer section 8 of the main spindle section 3 at the rotary joint 6. In machining, the workpiece 4 in which a prepared hole is machined in its center is held by the workpiece holder 7 of the main spindle section 3 of the general-purpose NC lathe etc. in a predetermined dimension state. After bringing the switch valve 32 of the back coolant supply section 5 into the open state and the switch valve 34 into the closed state and supplying the coolant, the main spindle is rotated at a predetermined rotation speed. The X slide 10 is moved to make the center of the workpiece 4 coincide with the center of the machining tool 2. In this state, by operating and moving a Z slide 9 to a predetermined position, it is made possible to machine a small diameter and small angle tapered deep hole in a short time by machining the workpiece 4 using the small diameter and small angle tapered deep hole vibration machining device 1 while supplying coolant.

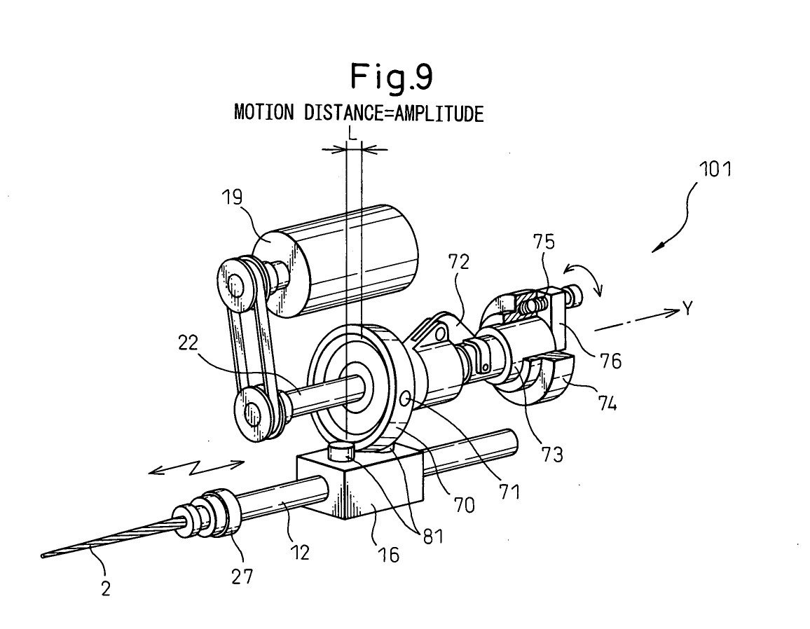

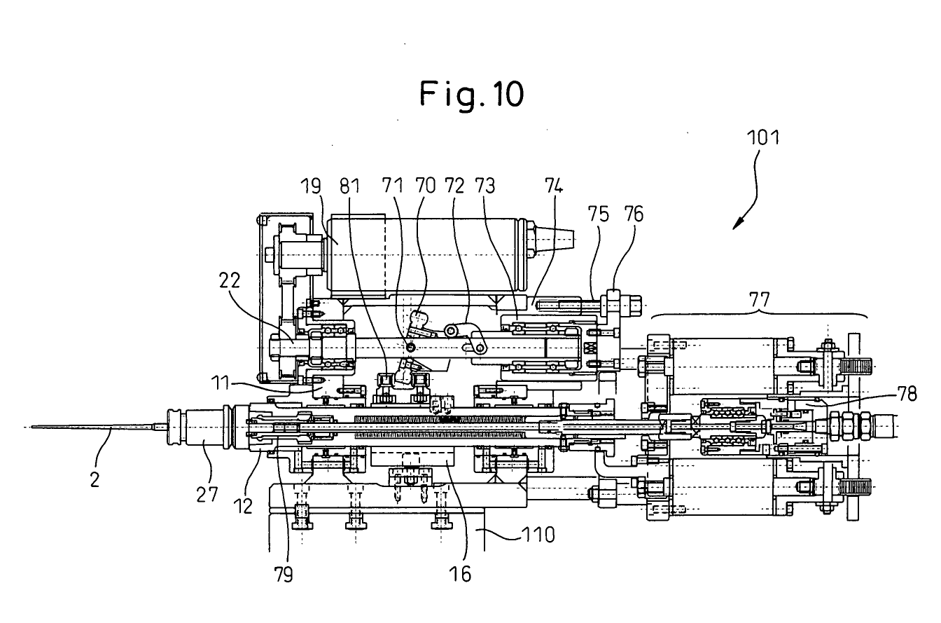

Referring to FIG. 9 and FIG. 10, a vibration machining device 101 in a third embodiment of the present invention that enables small diameter and small angle tapered deep hole machining is shown. FIG. 9 shows an illustrative perspective view of the vibration machining device 101 in the third embodiment and FIG. 10 is a side sectional view of the vibration machining device 101 in the third embodiment. In FIG. 9 and FIG. 10, the same components as, or components similar to, those in the first embodiment shown in FIG. 1 and FIG. 2 are denoted by the same reference symbols. The vibration machining device 101 comprises the vibration spindle 12, the pneumatic actuator 19, and a swash plate 70, where the swash plate 70 is a component that is a replacement of the vibration cam 23 in the first embodiment. These components are incorporated in a frame, not shown, as in the first embodiment.

In the present embodiment, the rotation of the pneumatic actuator 19 that generates vibrations of the machining tool 2 when performing small diameter and small angle tapered deep hole machining causes the shaft 22 to rotate via a pulley and a belt. The swash plate 70 is attached to the shaft 22 by a pin 71 and rotates together with the rotation of the shaft 22. The swash plate 70 is a disc-shaped component inclined with respect to the axis of the shaft 22 and the outer circumferential edge of the disc surface of the swash plate 70 is sandwiched by a pair of roller guides 81 so as to come into contact therewith, as seen from FIG. 9, and when the swash plate 70 rotates together with the shaft 22, the swash plate 70 slides between the pair of roller guides 81. Due to this, the roller guides 81 sandwiching the outer circumferential edge of the disc surface of the swash plate 70 produce reciprocation or a reciprocating linear motion in the direction Y of the axis of the shaft in accordance with the rotation of the swash plate 70 because the swash plate 70 is inclined with respect to the axis of the shaft 22. The roller guides 81 are provided at the holder 16, the holder 16 is attached to the vibration spindle 12, and the machining tool 2 is detachably attached to the front end of the vibration spindle 12 by means of the tool holder 27. The axis of the vibration spindle 12 is substantially parallel to the axis of the shaft 22, therefore, the rotation of the swash plate 70 is converted into reciprocation or a reciprocating linear motion, that is, vibrations, of the machining tool 2 via the roller guides 81 and the holder 16. In the present embodiment, the swash plate 70 and the roller guides 81 constitute the motion conversion mechanism set forth in claims and the holder 16 constitutes the transfer mechanism set fort in claims.

As the swash plate 70 is provided in the present embodiment, it is possible to change the amplitude of vibration of the machining tool 2 by changing the inclination angle of the swash plate 70. A method for changing the inclination of the swash plate 70 and a swash plate inclination angle change mechanism therefor are explained below. The swash plate 70 is attached to the shaft 22 by the pin 71, however, it can rotate around the pin 71 and therefore, the inclination angle can be changed. To the swash plate 70 on the opposite side of the pulley, an arm 72 is linked and to the arm 72 on the opposite side of the swash plate, a slide block 73 is linked. The slide block 73 can rotate via bearings etc. and can also move in the right and left direction (in the axial direction of the shaft 22) with the shaft 22 acting as a guide. In this configuration, even the shaft 22 and the swash plate 70 rotate, the slide block 73 stays in a state in which it does not rotate. Further, a stay 76 is attached to the slide block 73 with bolt, etc. and as shown in FIG. 10, the stay 76 is fixed to a metal 74 (corresponding to the frame 11), which is a structural section of the vibration machining device 101, with bolt etc. The metal 74 is provided with a screw hole and a motion change screw 75, which is the drive mechanism set forth in the claims, is inserted into the screw hole.

In this configuration, when the motion change screw 75 is turned to the left (in the counterclockwise direction) to move along the Y axis (the shaft axis) from the left to the right in FIG. 10, it moves in such a manner to depart from the metal 74 and, therefore, the slide block 73 also moves to the right along the shaft 22 accordingly, and as it pulls the swash plate 70 in the rightward direction via the arm 72, the inclination angle of the swash plate 70 increases. When the inclination angle of the swash plate 70 increases, the vibration amplitude of the roller guide 81 and therefore, the vibration amplitude of the vibration spindle 12 and that of the machining tool 2 increases.

On the other hand, when the motion change screw 75 is turned to the right (in the clockwise direction) to move along the Y axis (the shaft axis) from the right to the left in FIG. 10, it moves in such a manner to come near to the metal 74 and, therefore, the slide block 73 also moves to the left along the shaft 22 accordingly, and as it pushes the swash plate 70 in the leftward direction via the arm 72, the inclination angle of the swash plate 70 decreases. Due to this, the vibration amplitude of the vibration spindle 12 and that of the machining tool 2 decrease.

By operating the motion change screw 75 as described above, it is possible to change the position of the front of the swash plate by changing the inclination angle of the swash plate 70, and the distance in which the position of the swash plate front travels is preferably 0 to 7.5 mm, and the corresponding amplitude is 0 to 15 mm. Further, in the present embodiment, it is also possible to change the amplitude even during the period of machining and, therefore, it is made possible to automatically control the inclination angle of the swash plate 70 therefore the vibration amplitude of the machining tool 2 by attaching a control actuator (not shown) such as a stepping motor, a servo motor, or a pneumatic or hydraulic motor to the motion change screw 75 and, thus optimum machining conditions can be set.

FIG. 10 is a side sectional view of the vibration machining device 101 in the third embodiment, also showing a state of an actual embodiment. While FIG. 2 shows a state in which the vibration machining device 1 in the first embodiment is attached to the tool rest of a general-purpose lathe, FIG. 10 shows a state in which the vibration machining device 101 in the third embodiment is attached to a table 110 of a machine tool. In the state shown in FIG. 10, the vibration machining device 101 further comprises a tool holder clamping unit 79, and a drive unit 77 for driving the tool holder clamping unit 79 and a coolant supply joint 78 are provided. With this configuration, it is made easier to attach and detach the machining tool 2 from the tool holder 27 for holding the tool 2 and mass production machining becomes possible.

Further, the configuration comprising the shaft 22, the swash plate 70, the pin 71, the arm 72, the slide block 73, the metal 74 and the stay 76, and the motion change screw 75 is made clearer by the side sectional view shown in FIG. 10 and its operation described above is also well understandable from FIG. 10.

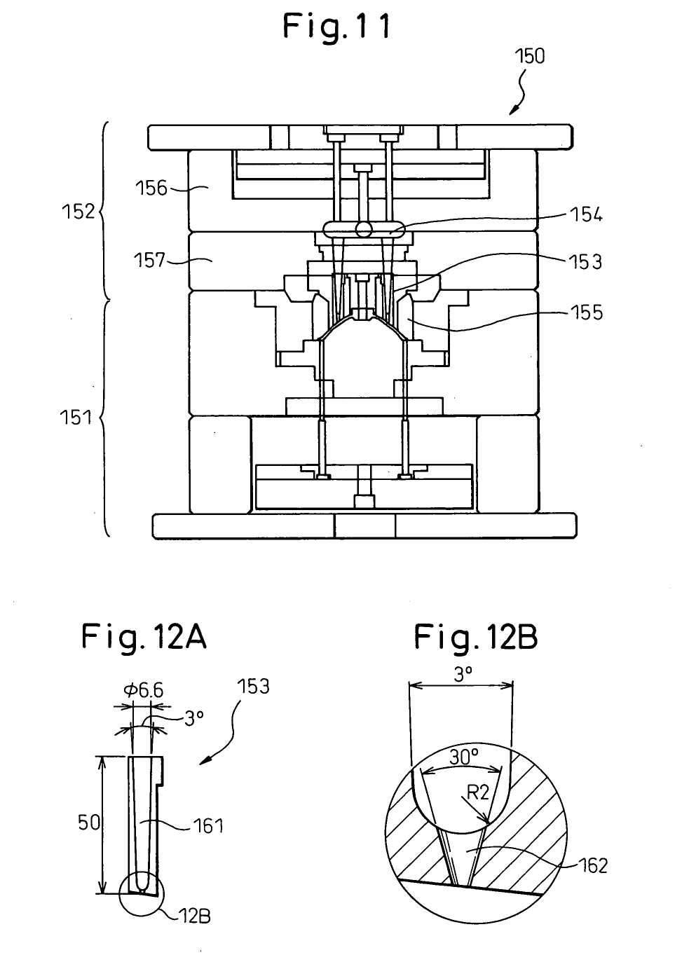

FIG. 8 is an example of machining of an ejector nozzle, and according to the vibration machining device 101 in the present embodiment, it can be applied to the machining of a gate bush, which is a resin injection part for molding die (a part that is in contact with a product molding section and which injects molten resin into a die). FIG. 11 is a side sectional view showing the outline of a resin molding die 150 and FIG. 12A shows a side sectional view of the entire shape of a gate bush 153 and FIG. 12B shows a detailed sectional view 12B of an injection section. The resin molding die 150 comprises a lower die 151 and an upper die 152 and the gate bush 153, which is a resin injection part, is attached to the upper die 152 in the case of the resin molding die 150 shown in FIG. 11.

In a state in which the upper die 152 and the lower die 151 are in close contact, a resin is ejected from an ejection device and the resin passes through a resin gate 154 and through the gate bush 153, and is injected into the die. When opening the mold after the resin is cooled to an appropriate temperature, a molded product 155 and a resin injection path are separated. Further, the resin in the gate bush 153 is pulled out when a die 156 is separated from a die 157. If the inner surface of the gate bush 153 is smooth, the resistance when the resin is pulled out is small, however, if the resistance is large, a problem arises that the resin remains in the gate bush 153. The gate bush 153 is an important component in this situation, therefore, it needs to be finished to be precise and smooth.

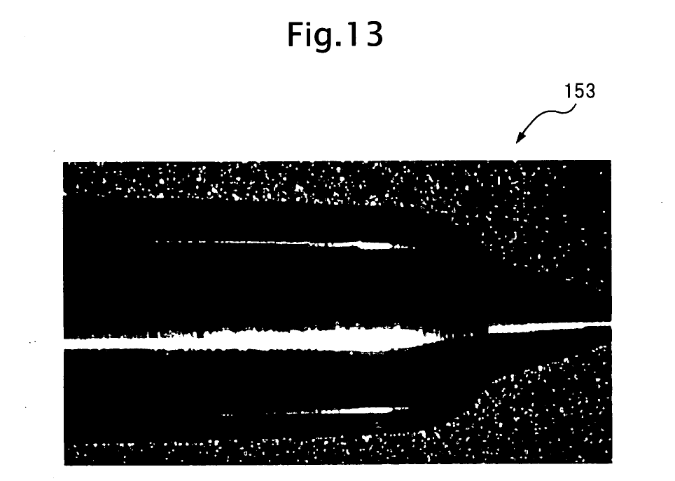

An example of general dimensions of the gate bush 153 is shown in FIGS. 12A and 12B. In the example shown in FIG. 12A, the gate bush 153 has a length of 50 mm and the diameter of an opening 161 is 6.6 mm and the inclination of the opening 161 is 3°. The end of the opening 161 at an injection section 162 shown in FIG. 12B is finished so as to have a sphere shape of R2 and a cone-shaped opening with an inclination angle of 30° is machined at its front. FIG. 13 shows an example of the gate bush 153, having such a complex-shaped opening and machined by the vibration machining method using the vibration machining device 101 in the present embodiment, showing the vicinity of the injection section in a state in which it is cut at its central part. In conventional machining of the gate bush 153, inner taper machining is performed by the electric machining method after prepared hole machining is performed, therefore, its machining requires a long time. Further, it is necessary to manufacture an electrode required for machining each time. The cutting of a gate bush by the vibration machining method in the present embodiment can be reduced, in machining time, by a factor of 10 compared to the conventional machining and the machining tool can be used repeatedly, the machined surface is more excellent compared to the case of the electric machining method, and the resistance when resin is injected etc. can be reduced.

In the above-mentioned third embodiment, the inclination of the swash plate 70 is adjusted by moving the swash plate 70 using the motion change screw 75, however, the motion change screw may be replaced with a drive device known to those with ordinary skill in the art, such as rack-and-pinion type drive device and a pneumatic or a hydraulic cylinder.

Next, the effect and function of the above-mentioned embodiments are described below.

From the vibration machining device in the first embodiment of the present invention, the following effects can be expected

In order to improve the machining efficiency of small diameter and small angle tapered deep hole machining, the biting phenomenon of a taper-shaped cutting tool is focused on, and the biting is prevented by applying vibrations with low frequencies and great amplitudes to the cutting tool to reduce the load on the blade edge of the cutting tool and, at the same time, by using a modified sine curve as a vibration waveform.

In machining a small diameter and small angle tapered deep hole such as an ejector nozzle, it is possible to machine a taper of an about 1° highly precisely and in a short time.

The tool itself attached to the vibration machining device is a kind of cutter and does not rotate itself but reciprocates, and the workpiece to be machined is rotated to machine a deep hole and, therefore, it is possible to machine a small diameter and small angle tapered deep hole with less error at the hole center.

From the machining equipment in the second embodiment of the present invention, the following effect can be expected in addition to the effects in the above-mentioned first embodiment.

It is possible to improve machining efficiency by supplying the pressurized coolant from behind a workpiece for cooling and lubrication when drilling and at the same time, by improving the performance of removing and discharging the coolant mixed with cutting chips when machining the prepared hole.

From the vibration machining device in the third embodiment of the present invention, the following effects can be expected in addition to the effects in the first embodiment.

As the configuration comprises the swash plate capable of changing the inclination angle, it is possible to easily adjust the amplitude of the reciprocating machining tool to an optimum value without replacement of the swash plate and it is also possible to adjust the amplitude during the period of machining.

As it is possible to adjust the amplitude of vibration during the period of machining, it is possible to set up optimum machining conditions with automatic control by attaching an automatically-controllable actuator to the motion change screw.

For example, in machining a product having a complex and precise opening such as a gate bush for a resin molding die, the machining time can be reduced to about one-tenth compared to the conventional machining method, the machining tool can be used repeatedly, the finished surface is in more excellent condition, and the resistance when resin is ejected etc. can be reduced.

In the above-mentioned explanation, the vibration machining device of the present invention is described to be applied to facilities for performing the machining of a small diameter and small angle tapered deep hole in a workpiece such as ejector nozzle, however, the present device may be applied to facilities for drilling other than the machining of a small diameter and small angle tapered deep hole, and further may be applied for purposes other than drilling.

In the embodiments described above or shown in the accompanying drawings, the pneumatic actuator 19 is explained as a pneumatic motor, however, already-known rotary drive devices such as an electric or a hydraulic motor may be used instead, and the components used in the above-mentioned embodiments as described above may be replaced with devices, parts, etc., of already-known various types.

Further, in the embodiments described above or shown in the accompanying drawings, the pneumatic circuit for operating and controlling the small diameter and small angle tapered deep hole machining device 1 is shown in FIG. 4, however, this is only an example, and components may be added to the circuit or components may be added or removed as the need arises, and further, the pneumatic circuit may be changed or modified to an extent which those with ordinary skill in the art can make.

The above-mentioned embodiments are only examples of the present invention and the present invention is not limited by the above-mentioned embodiments but specified only by the claims set forth below, and embodiments other than those described above are also possible.

While the invention has been described by reference to specific embodiments chose for the purposes of illustration, it should be apparent that numerous modifications could be made thereto, by those skilled in the art, without departing from the basic concept and scope of the invention.

1. A vibration machining device comprising:
a frame that forms a structure of the vibration machine device;
a shaft rotatably held by the frame;
an actuator for rotatably driving the shaft;
a motion conversion mechanism attached to the shaft for converting a rotational motion into a reciprocating motion;
a spindle for holding a machining tool and supported in the frame so as to be capable of reciprocating in an axial direction of the spindle; and
a transfer mechanism for transferring the reciprocating motion of the motion conversion mechanism such that the spindle reciprocates in the axial direction thereof.

2. The vibration machining device as set forth in claim 1, wherein the reciprocating motion of the motion conversion mechanism describes a modified sine curve during the period of one complete rotation of the motion conversion mechanism.

3. The vibration machining device as set forth in claim 2, wherein the modified sine curve described by the reciprocating motion of the motion conversion mechanism is such that, during the period of one complete rotation of the motion conversion mechanism, a height of the modified sine curve gradually increases from a position of a lower dead center toward a position of an upper dead center and gradually decreases from the position of the upper dead center toward the position of the lower dead center, and the modified sine curve has constant level parts without displacement of reciprocation in a specific rotation angle range of the modified sine curve in the vicinity of the position of the lower dead center and in a specific rotation angle range thereof in the vicinity of the position of the upper dead center.

4. The vibration machining device as set forth in claim 3, wherein the specific rotation angle range in the vicinity of the position of the lower dead center and the specific rotation angle range in the vicinity of the position of the upper dead center, in which the constant level parts are formed, are a range between substantially ±5 degrees to a range between substantially ±15 degrees when the position of the lower dead center and the position of the upper dead center are the centers of the specific rotation angle ranges, respectively.

5. The vibration machining device as set forth in claim 3, wherein during the period of one complete rotation of the motion conversion mechanism, which corresponds to 360 degrees, if the position of the lower dead center is assumed to be at zero degree, the position of the upper dead center is at 180 degrees.

6. The vibration machining device as set forth in claim 1, wherein:
the motion conversion mechanism comprises a cam attached to the shaft and a roller;
a cam surface of the cam is formed such that height of the cam surface changes in a direction of a rotation axis of the shaft when the cam rotates together with the shaft; and
as the roller is engaged with the cam surface, the roller reciprocates when the shaft rotates.

7. The vibration machining device as set forth in claim 1, wherein:
the motion conversion mechanism comprises a swash plate attached to the shaft so as to incline with respect to the rotation axis of the shaft and a pair of roller guides;
the pair of roller guides is arranged so as to be adjacent to and sandwich an outer circumferential edge of the swash plate and as the swash plate slides between the pair of roller guides when rotating, the roller guides reciprocate; and
the roller guides are connected to the transfer mechanism.

8. The vibration machining device as set forth in claim 7, further comprising a swash plate inclination angle change mechanism for changing an inclination angle of the swash plate with respect to the shaft.

9. The vibration machining device as set forth in claim 8, wherein the swash plate inclination angle change mechanism comprises:
a pin that connects the swash plate to the shaft and around which the swash plate can rotate;
a slide block that can move along the shaft;
an arm that links the swash plate and the slide block; and
a drive mechanism that can move the slide block along the shaft.

10. The vibration machining device as set forth in claim 9, wherein the drive mechanism comprises a drive device such as a stepping motor, a servomotor, and a pneumatic or hydraulic actuator, and is automatically controlled so as to optimize vibration amplitude of the machining tool.

11. The vibration machining device as set forth in claim 1, wherein the vibration machining device is used for machining a small diameter and small angle tapered deep hole.

12. The vibration machining device as set forth in claim 11, wherein taper of the small diameter and small angle tapered deep hole is about one degree.

13. The vibration machining device as set forth in claim 1, wherein the vibration machining device is attached to a drilling device, the drilling device comprises a main spindle that rotates and the vibration machining device drills a workpiece by vibrating the machining tool attached to the vibration machining device while rotating the workpiece set to the main spindle.

14. Machining equipment for supplying a coolant liquid for cutting to a machine tool, comprising:
a first connection opening communicating the supply source of a coolant liquid;
a second connection opening communicating the machine tool;
a first channel for fluidly connecting the first connection opening and the second connection opening;
a second channel branching from the first channel;
a third connection opening capable of making the coolant liquid flowing through the second channel flow out or flow in the machining equipment;
a first switch valve installed on a side nearer to the first connection opening than a branching point of the second channel in the first channel and opening and closing the first channel;
and a second switch valve installed on the side nearer to the third connection opening than the branching point of the second channel, in the second channel and opening and closing the third channel.

15. The machining equipment as set forth in claim 14, wherein the machine tool has a rotary spindle that rotates and the machining equipment further comprises a rotary joint of swivel type that can be connected to the rotary spindle at the second connection opening.

16. The machining equipment as set forth in claim 14, wherein the first switch valve and the second switch valve are remotely operated.

17. The machining equipment as set forth in claim 14, further comprising the vibration machining device set forth in claim 1, wherein the machining equipment is used in combination with the vibration machining device.

18. A vibration machining method for drilling a small hole, comprising:
a step for machining a prepared hole in a workpiece by electrical discharge machining, gun drill machining, or the like; and
a step for machining the prepared hole in a taper hole by inserting the machining tool into the prepared hole while rotating the workpiece and vibrating, that is, reciprocating the machining tool in a direction parallel to the rotation axis of the workpiece.

19. The vibration machining method as set forth in claim 18, wherein:
the prepared hole is a through hole in the step for machining a prepared hole; and
it further comprises a step for inserting the machining tool from one end of the prepared hole and supplying a coolant liquid from the other end of the prepared hole.

20. The vibration machining method as set forth in claim 18, further comprising a step for adjusting the amplitude of vibration of the machining tool to an optimum value.

21. The vibration machining method as set forth in claim 18, wherein the vibration machining device set forth in claim 1 is used.

22. The vibration machining method as set forth in claim 19, wherein the machining equipment set forth in claim 17 is used.

23. The vibration machining method as set forth in claim 22, wherein the coolant liquid is supplied from a tool side in the step for machining a prepared hole and as the first switch valve is closed and the second switch valve is open in the machining equipment, the coolant liquid is discharged through the third connection opening of the machining equipment when the prepared hole is completed.

24. A method for manufacturing an ejector for refrigerating cycle in which a taper hole is machined in an ejector nozzle using the vibration machining method set forth in claim 18.
